(19) United States
(12) Patent Application Publication
(10) Pub. No.: US 2003/0006905 A1
(43) Pub. Date: Jan. 9, 2003

(54) Blue tooth power switch apparatus

(76) Inventors: Jay Shieh, Bayside, NY (US); Yen-Hui Tsai, Hsintien (TW); Ching-Yi Lin, Panchiao (TW)

Correspondence Address: BAKER & BOTTS, 30 ROCKEFELLER PLAZA, NEW YORK, NY, 10112

(21) Appl. No.: 09/901,369

(22) Filed: Jul. 9, 2001

(51) Int. Cl. H02J 1/00

(52) U.S. Cl. 340/825.69; 307/11

(57) ABSTRACT

The present invention provides a new power switch apparatus design. Under this kind of design, a blue tooth module is placed in this power switch apparatus which receives signal from blue tooth control device. Control devices having blue tooth module may make up a wireless link to the power switch apparatus of this present invention. These devices having a blue tooth controllable function can remotely monitor and control the power switch of the power switch apparatus. On the other hand, the power switch apparatus may send the power consumption information itself to the a device that has a blue tooth controllable function. Therefore, the present invention's apparatus may provide a two-way communication between the power switch apparatus and the control device having blue tooth module.

### FIELD OF THE INVENTION

This invention relates to a power switch apparatus and more particularly to a power switch apparatus having blue tooth technology.

### BACKGROUND OF THE INVENTION

Ordinary electrical devices that use AC power usually have a build-in master switch that turns the power on or off to all outlets. Therefore, to turn on or off all the power a user must physically be able to reach the device, typically located on the electric machine, to access the master switch. Alternatively, if the user wants to selectively turn off separate devices, the user must directly access the power switch apparatus of each separate device.

If a user wants to control all of the electronic devices remotely at same time, it would require some special wireless control devices. These wireless device modules have to be plugged into the AC wall outlet. The power sockets of the electronic devices can be plugged into the wireless device modules. This allows the electronic device to be control remotely with a remote control. One major drawback to the foregoing remote control, however, is that it can only control these wireless device modules in a very short range. Also only this remote control can monitor the whole wireless power control system.

### SUMMARY OF THE INVENTION

With these foregoing problems, requiring a special remote unit and only being able to control a switch remotely a in short range, it is the objective of the present invention to provide a new power switch apparatus design to solve the aforementioned problems. Under the new power switch apparatus design of the present invention, any electrical device connected to the present invention's power switch apparatus can be turned on or off by a universal remote unit, and the remote unit will be the master control of the whole power switch apparatus. Also the signals used by the whole system are universal.

To achieve the above-mentioned objective, the present invention provides a new power switch apparatus design. Under this kind of design, a blue tooth module is placed in the power switch apparatus. A control device having blue tooth module may make up a wireless link with the power switch apparatus of this present invention. Blue tooth protocol is a universal signal among all control devices having blue tooth module and power switch apparatus. Therefore, any control device having blue tooth module may control these power switch apparatuses of the present invention. On the other hand, it can make two-way communication between the power switch apparatus and the control device having blue tooth module.

The power switch apparatus according to the present invention comprises a blue tooth module which handles the wireless communication and receives a control signal from a control device having a blue tooth module. A MCU controller receives a control signal from the blue tooth module and sends a switch signal to the power control and detect. The power control's switch and detect may make power on/off according the switch signal. On the other hard, the power control's sensor and detect may monitor the power consumption status of a connecting load and send the status information to the MCU controller. The MCU controller transfers the signal to digital signal and sends them to the control device having the blue tooth module via the blue tooth module of the present invention.

### BRIEF DESCRIPTION OF THE DRAWINGS

The foregoing aspects and many of the attendant advantages of this invention will become more readily appreciated and better understood by referencing the following detailed description, when taken in conjunction with the accompanying drawings, wherein:

FIG. 1 illustrates the schematic diagram of the preferred embodiment of the power switch apparatus.

FIG. 2 illustrates the schematic diagram of another preferred embodiment of the power switch apparatus.

FIG. 3 illustrates a lateral view of the preferred embodiment of the power switch apparatus of the present invention.

FIG. 4 illustrates a top view of the preferred embodiment of the power switch apparatus of the present invention.

### DETAILED DESCRIPTION OF THE EMBODIMENT

Without limiting the present invention's spirit and scope, the method proposed in the present invention is an illustration with one preferred embodiment about a new kind of layout pattern design of read only memory. People who are knowledgeable about the embodiments can apply the new design on any kind of power switch apparatus to eliminate the shortcomings of requiring a special remote unit and only being able to control the switch remotely in a short range. The usage of the present invention should not be limited by the embodiment as follows.

Blue tooth technology provides a universal radio interface that enable electronic devices having a blue tooth function to connect and communicate wirelessly via a short range ad hoc network. A blue tooth sensor module can be placed in a power switch apparatus receiving control signals to control its on/off function. Any control devices that have blue tooth functions can control these power switch apparatuses. Blue tooth can form a master/slave configuration. The control device having a blue tooth function, as a master, may control over 7 power switch apparatuses, as a slave. Each power switch apparatus can be liked to another power switch apparatus. This would make up a network of chained power switch apparatuses. Since blue tooth protocol is a universal signal among all blue tooth control devices. Any blue tooth control device such as a computer, PDA, cellular phone, can control these blue tooth power switch apparatuses.

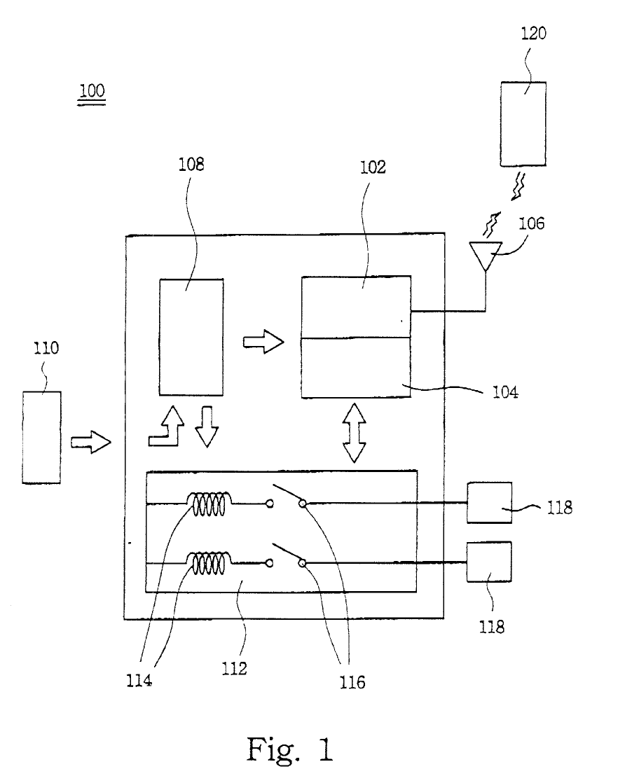

Referring to FIG. 1, it illustrates the schematic diagram of the power switch apparatus 100 of the present invention, wherein the power switch apparatus 100 of the preferred embodiment is a wall plug The power switch apparatus 100 comprises an a blue tooth module 102 and an MCU controller 104 which are the heart of the power switch apparatus, wherein the blue tooth module 102 handles the wireless communication function. Blue tooth protocol is universal, therefore, it can also communicate with other devices having a blue tooth function at the same time. On the other hand, the MCU controller 104 receives an analog signal from the antenna 106, which may send and receive blue tooth protocol, and then transfers the analog signal to digital signal. The MCU controller may send and receive the signal via the blue tooth module. A AC to DC circuit 108 couples with the main AC power source 110 which is used to convert AC power to DC power to supply the blue tooth module 102 and the MCU controller 104 with a DC power source. The power control and detect 112 contains two parts, the sensor 114 and the switch 116. The sensor 114 is used to monitor the AC power consumption of the load 118 and gives this information to MCU controller 104 which also receives a command from the MCU controller 104. The switch 116 couples with the sensor 114 and the sensor 114 may send MCU controller's command to the switch 116, then the switch 116 can be on/off according to the receiving command. The switch 116 can be a traditional relay or a semiconductor, which can control the AC power ON/OFF. The switch 116 can also be forced on/off for a special purpose.

The following describes a preferred embodiment of the present invention. When the power switch apparatus 100 according to the present invention connects to the main AC power source, AC to DC circuit 108 will start and give blue tooth module 102 an appropriate DC power. At the first state, the sensor 114 and the switch 116 are in an off state and the blue tooth module 102 is in a stand-by state. When the blue tooth nodule 102 of the present invention is in a stand-by state, it can only listen to other blue both modules. When the blue tooth module 102 of the present invention receives other devices 120 having a blue tooth controllable function having blue tooth module inquires, such as PDAs, cellular phones, computers and so on, the power switch apparatus 100 of the present invention will return its global ID to the inquiring devices 120 having a blue tooth controllable function. At the same time, the inquiring device 120 having a blue tooth controllable function may also send its information to the power switch apparatus 100. Therefore, the power switch apparatus 100 will know the inquiring blue tooth control device ID. This will make up a wireless link between the power switch apparatus 100 and the device 120 having a blue tooth controllable function. Because any device 120 having a blue tooth. Controllable function may form a wireless link with a power switch apparatus of the present invention. The present invention does not require any special device 120 having a blue tooth controllable function, which increases the convenience of uses. When the wireless link is made, the device 120 having a blue tooth controllable function may give the power switch apparatus 100 command. For example, power on/off the load 118 which couples with the power switch apparatus 100 and monitor and detect the load 118 status and location and so on.

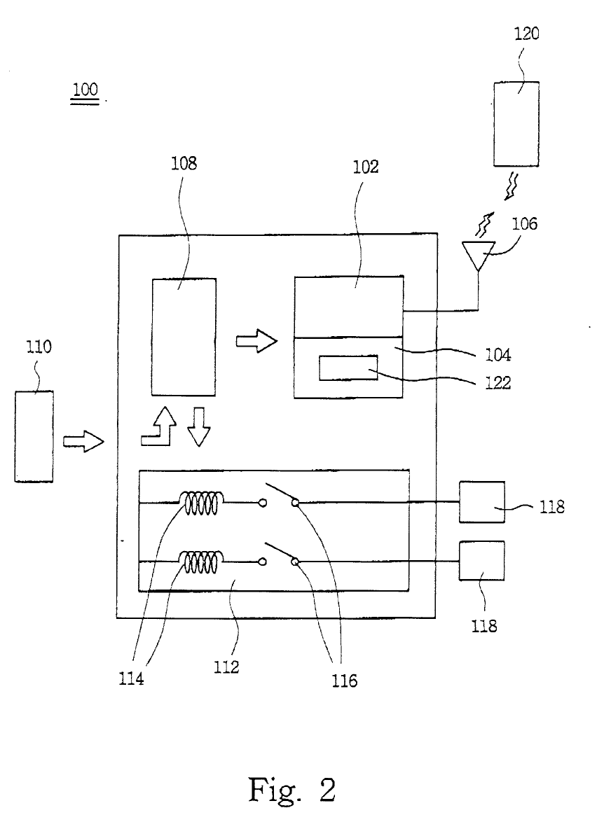

When operating, first, the device 120 having blue tooth controllable function will send a signal to the power switch apparatus built in antenna 106, wherein the device 120 carries blue tooth protocol such as desktop computers, PDAs, cellular phones and others. Then, the blue tooth module 102 will send the signal received from the antenna 106 to the MCU controller 104 to control the switch 116 to be either on/off according to the received signal, wherein the blue tooth module is used to handle the wireless communication. On the other hand, when the switch 116 is closed, which means the load 118 is connected to the AC power, the sensor 114 will monitor the AC power consumption of the load 118 in real time and gives this consumption information to the MCU controller 104 in real time. It should be noticed that the received information by the MCU controller 104 is analog signal, therefore, the MCU controller 104 will transfer the received information to digital signal first and then send it to the blue tooth module 102. The blue tooth module 102 will transfer the wireless communication and to inform the device 120 the load 118 current status. The blue tooth protocol is universal, therefore, the power switch apparatus 100 is not a traditional power switch apparatus requiring a special remote control device. On the other preferred embodiment, referring to FIG. 2, a timer 122 is located within the MCU module. At this time, the device 120 having blue tooth controllable function may give the power switch apparatus 100 a command to set its power on/off.

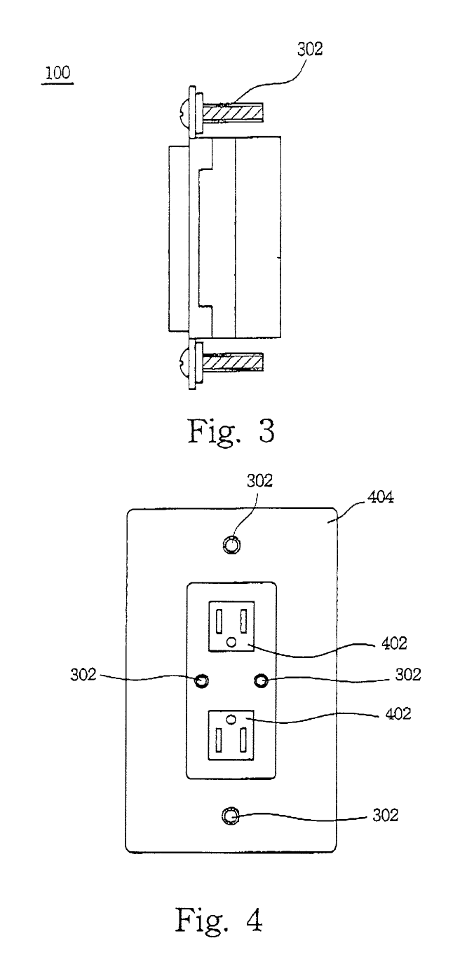

Referring to FIG. 3, this figure illustrates a lateral view of the preferred embodiment of the power switch apparatus 100 of the present invention. The metal screw 302 is used to hold the power switch apparatus 100 in a special area, such as a wall. Referring to FIG. 4, this figure illustrates a top view of the preferred embodiment, wherein the metal screw 302 is used lo hold the power switch apparatus 100. A plastic plate 404 is used to protect the inner power switch apparatus 100. The AC electric plug 402 is used to supply the load AC power. If the load plugs into the AC electric plug 402, the load may be controlled to power on/off by wireless device. On the other hand, the power consumption status of the load may also be sent to the blue tooth controlled device to tell the users via the wireless transmission.

As is understood by a person skilled in the art, the foregoing descriptions of the preferred embodiment of the present invention is an illustration of the present invention rather than a limitation thereon. Still more configurations and variations could be implemented by persons skilled in the art. It is intended to cover various modifications and similar arrangements included within the true scope of the appended claims. The scope of the claims should be accorded the broadest interpretation so as to encompass all such modifications and similar structures. While the preferred embodiment of the invention has been illustrated and described, it will be appreciated that various changes can be made therein without departing from the spirit and scope of the invention.

What is claimed is:

1. A power switch apparatus, comprising:
a communication module which handle a wireless communication function and receives a command signal;
a controller coupling with said communication module to receive and send said command signal;
a plurality of switches coupling with said controller to receive said command signal from said controller to make said plurality of switches on/off according to said received command signal; and
a plurality of sensors coupling said a plurality of switches respectively and sensing a power status.

2. The power switch apparatus of claim 1, wherein said communication module is a blue tooth module.

3. The power switch apparatus of claim 1, wherein said command signal received by said communication module is sent by a device having blue tooth function.

4. The power switch apparatus of claim 1, wherein said controller may transfer an analog signal to a digital signal.

5. The power switch apparatus of claim 1, wherein said controller further comprises a timer.

6. The power switch apparatus of claim 1, wherein said command is one of power on command, power off command, forced on command and forced off command.

7. The power switch apparatus of claim 1, wherein said sensors may send said power status to a device having blue tooth function over said communication module.

8. The power switch apparatus of claim 1, wherein said sensor to sense the power status means to sense the power status of a load coupling with said sensor.

9. The power switch apparatus of claim 1, wherein said power switch apparatus is a wall plug.

10. A power switch apparatus having blue tooth function, comprising:
a blue tooth module which handles a wireless communication function and receives a command signal from a device having blue tooth function;
a controller coupling with said blue tooth module to receive and send said command signal;
a plurality of switches coupling with said controller to receive said command signal from said controller to make said plurality of switches on/off according to said received command signal; and
a plurality of sensors coupling said plurality of switches respectively and sensing a power status of loads, wherein said plurality of sensors may send said power status to said control device via said blue tooth module.

11. The power switch apparatus of claim 10, wherein said controller may transfer an analog signal to a digital signal.

12. The power switch apparatus of claim 10, wherein said controller further comprises a timer.

13. The power switch apparatus of claim 10 wherein said command signal is one of power on command, power off command, forced on command and forced off command.

14. The power switch apparatus of claim 10, wherein said power switch apparatus is a wall plug.

15. A wall plug having a blue tooth function, comprising:
a convert circuit to convert AC power to DC power;
a blue tooth module coupling with said convert circuit which handles a wireless communication function and receives a command signal from a control device having said blue tooth function;
a controller coupling with said blue tooth module to receive and send said command signal;
a plurality of switches coupling with said controller to receive said command signal from said controller to make said plurality of switches on/off according to said received command signal; and
a plurality of sensors coupling said plurality of switches respectively and sensing a power status of loads, wherein said plurality of sensors may send said power status to said control device via said blue tooth module.

16. The power switch apparatus of claim 15, wherein said controller may transfer an analog signal to a digital signal.

17. The power switch apparatus of claim 15, wherein said controller further comprises a timer.

18. The power switch apparatus of claim 15, wherein said command signal is one of power on command, power off command, forced on command and forced off command.
